(19) United States
(12) Patent Application Publication
(10) Pub. No.: US 2018/0183915 A1
(43) Pub. Date: Jun. 28, 2018

(54) METHOD AND APPARATUS FOR CHANGING A MODE OF A DEVICE FROM A RIGHT-HAND MODE TO A LEFT-HAND MODE, AND VICE VERSA, OR TO A NORMAL MODE TO A HANDEDNESS MODE

(71) Applicant: MOTOROLA SOLUTIONS, INC, CHICAGO, IL (US)

(72) Inventors: DONG ZHAO, CHENGDU (CN); WEI CHU, CHENGDU (CN); QING-XIAO ZHENG, CHENGDU (CN)

(21) Appl. No.: 15/576,926

(22) PCT Filed: Aug. 20, 2015
(86) PCT No.: PCT/CN2015/087715

§ 371 Date: Nov. 27, 2017

(51) Int. Cl. H04M 1/02; G06F 3/0488; H04M 1/725

(52) U.S. Cl. CPC H04M 1/0281; H04M 2250/22; H04M 1/7253; G06F 3/0488

(57) ABSTRACT

A method and apparatus for changing a mode of a device from a first-handed mode to a second-handed mode is provided herein. During operation, the device will detect the use of other, differing devices. Based on the detected use of the other, differing devices, the device will switch from a first-handed mode of operation to a second-handed mode of operation.

### FIELD OF THE INVENTION

The present invention generally relates to changing an operating mode of a touch-screen device, and more particularly to a method and apparatus for changing a mode of a device from a right-hand mode to a left-hand mode, and vice versa or to a normal mode to a handedness mode.

### BACKGROUND OF THE INVENTION

Almost half of all touch screen users tend to use one hand to operate the device. One-handed use seems to be highly correlated with a user simultaneously performing other tasks. For example, one-handed use of a device almost always occurs when the user's other hand is performing another task. For example, many of those who use one hand to operate their touch-screen phone do so while carrying out other tasks such as carrying bags, steadying themselves when in transit, climbing stairs, opening doors, holding babies, and so on.

It is known to place items on a touch-screen in order to accommodate one-handed operation. For example, US Publication No. 2014/0101593 describes the placement of items on a touch screen so that a user may have an easier time operating the device with one hand. The placement of items on a touch screen to accommodate one-handed operation is based on whether or not the one-handed use of the touch screen will be with a user's right or left hand. For example, if a person is using their touch-screen device with their right hand, important items on the screen may be shifted to the first area of the touch screen. If a person is using their touch-screen device with their left hand, those important items may be shifted to a second area of the touch screen.

A problem exists with one-handed operation of a device when, for example, a touch-screen device operates in a one-handed mode that is opposite to the hand a user is actually operating the device with. For example, if a device is operating in a one-handed mode for right-hand operation (i.e., items shifted to the first area of the screen), the user will find the device difficult to operate if they are using the device solely with their left hand. Consider the case where a right-handed police officer is operating a touch-screen device with their right hand only. The device may operate in a mode that shifts items to the first area of the screen. If the officer pulls their gun with their right hand, operation of their device (if needed) will most certainly take place using their left hand, as the gun will be held in the officer's right hand. Having the device operating in a right-hand mode while holding the device in their left hand will make operation of the device difficult. Therefore, a need exists for a method and apparatus for changing operation of a device from a right-hand mode to a left-hand mode, and vice versa.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates switching a device from a first-handed mode of operation to a second-handed mode of operation.

FIG. 2 depicts a view of the personal-area network of FIG. 1.

FIG. 3 depicts a view of the personal-area network of FIG. 1.

FIG. 4 is a block diagram of a device shown in FIG. 1.

FIG. 5 is a flow chart showing operation of the device of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a method and apparatus for changing a mode of a device from a first-handed mode to a second-handed mode is provided herein. During operation, the device will detect the use of other, differing devices. Based on the detected use of the other, differing devices, the device will switch from a first-handed mode of operation to a second-handed mode of operation.

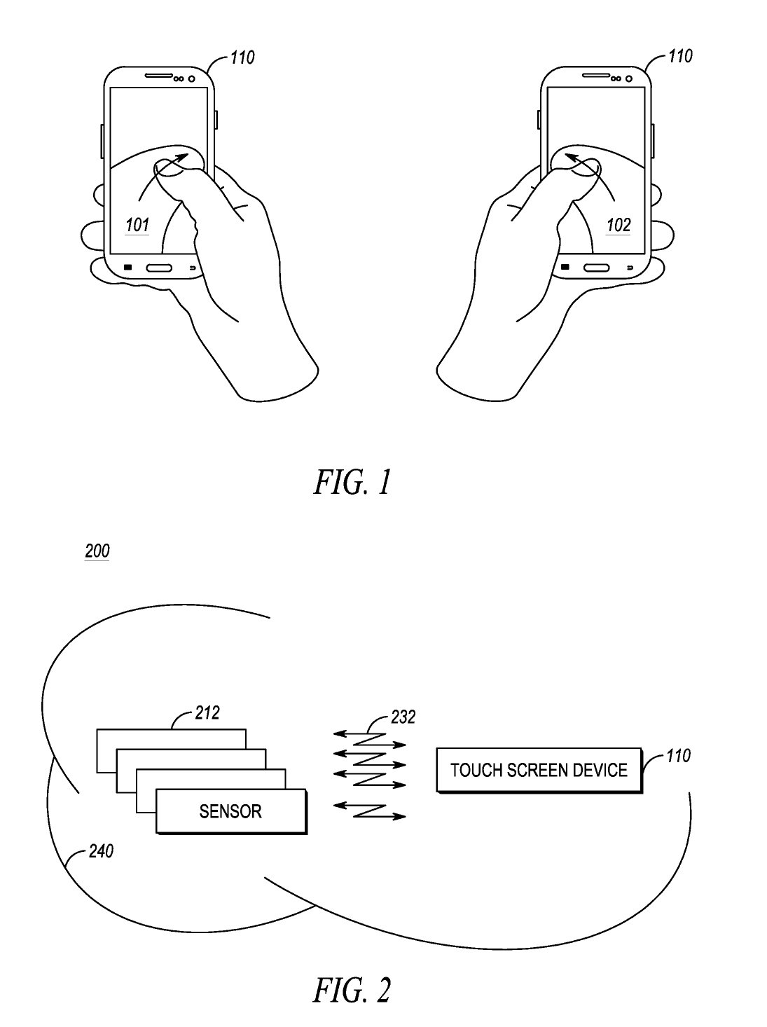

As an example of the above, consider the case where a right-handed police officer is operating a touch-screen device with their right hand only. The device may operate in a right-handed mode that shifts items to the first area of the screen. If the officer pulls their gun with their right hand, operation of their device (if needed) will then take place using a left-handed mode that shifts items to a second area of the screen. This is illustrated in FIG. 1.

As shown in FIG. 1, when device 110 is operating in a right-handed mode of operation, device 110 will preferably display important interface items (e.g., icons, buttons, soft keys, menus, buttons, knobs, and other user-interface elements) within a first area 101. When device 110 is operating in a left-handed mode of operation, device 110 will preferably display important interface items within a second, differing area 102. It should be noted, that the first area and the second area may be mutually exclusive (e.g., non-overlapping) or may overlap. As is evident, first area 101 occupies a different region of the touch screen than second area 102. As one of ordinary skill in the art will recognize, a normal mode of operation (normal handedness) will have no handed preference to the placement of objects on the touchscreen.

As is evident, switching the handed-mode of operation of device 110 will ease use of device 110 as the user switches from a first-handed mode of operation to a second-handed mode of operation.

FIG. 2 depicts an example system 200 for switching a mode of operation for device 110 from a first-handed mode to a second-handed mode. (It should be noted that the first and the second handedness modes may comprise a right-handed mode, a left-handed mode, and a normal-handed mode (normal mode of operation)). As shown, local sensors 212 and touch-screen device 110 form a local-area network 240. In a preferred embodiment of the present invention, touch-screen device 110 and sensors 212 form a body-area network 240, with communication links 232 between sensors 212 and touch-screen device 110 taking place utilizing a short-range communication system protocol such as a Bluetooth communication system protocol.

Touch-screen device 110 may be any suitable computing and communication devices configured to engage wired and/or wireless communication with one or more local sensor 212 via the communication link 232. Touch-screen device 110 will be configured to determine to change a mode of operation of device 110 from a first-handed mode to a second-handed mode of operation (e.g., from a right-handed mode of operation to a left-handed mode of operation, or from a left-handed mode of operation to a right-handed mode of operation, or from a normal mode of operation to a right/left handed mode of operation and vice versa). Touch-screen device 110 may comprise a cellular telephone, a two-way radio, a personal-digital assistant, a laptop computer, or any other device having a touch screen (or touch pad) that is capable of being operated with a single hand.

Preferably, sensors 212 may comprise any device capable of generating a current context, and indicate a use of other devices. For example, sensors 212 may comprise a GPS receiver capable of determining a location or speed of a vehicle. However, sensors 212 may additionally generate a context that will imply one-handed use of device 110. Such sensors 212 may comprise a clock, calendar, environmental sensors (e.g. a thermometer capable of determining an ambient temperature, humidity, presence of dispersed chemicals, radiation detector, etc.), an accelerometer, a barometer, speech recognition circuitry, a user's electronic calendar, short-range communication circuitry (e.g., Bluetooth™ circuitry) to determine what other electronic devices are near, a gunshot detector, a gun-drawn detector, a mobile audio or video analytic, a disarm sensor (switch/button), a taser sensor, a handcuff sensor, . . . , etc.

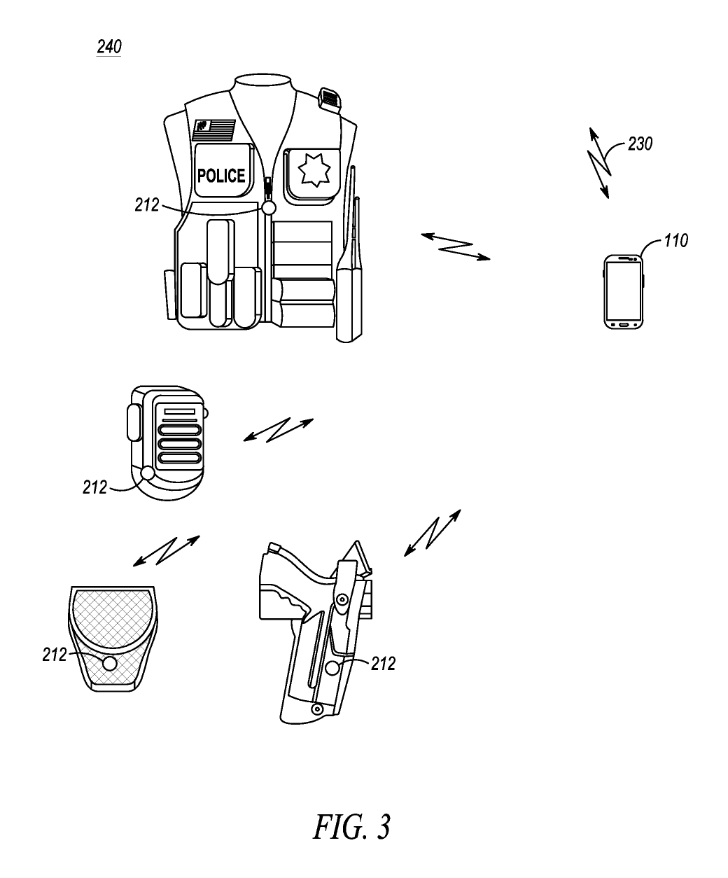

FIG. 3 depicts a view of the personal-area network 240 of FIG. 1. Personal-area network comprises a very local-area network that has a range of, for example 10 feet. As shown in FIG. 3, various sensors 212 are shown attached to equipment utilized by a public-safety officer. It should be noted that although FIG. 3 shows sensors attached to objects or devices, with the sensors providing data about the use of their attached devices, one of ordinary skill in the art will recognize that the actual devices or objects themselves may provide such use data. The Applicants draw no distinction, between a device providing use data, or a sensor attached to a device providing use data. This particular embodiment is described with sensors providing use data. For example, a bio-sensor is located within a police vest, a voice detector is located within a police microphone, a handcuff deployment sensor is located with a handcuff pouch, and a gun-draw sensor is located within a holster.

As discussed above, sensors 212 and touch-screen device 110 form a personal-area network (PAN) 240 or a local-area network (LAN). PAN/LAN 240 preferably comprises a Bluetooth piconet. Sensors 212 and touch-screen device 110 are considered Bluetooth devices in that they operate using a Bluetooth, a short range wireless communications technology at the 2.4 GHz band, commercially available from the “Bluetooth special interest group”. Sensors 212 and touch-screen device 110 are connected via Bluetooth technology in an ad hoc fashion forming a piconet that allows devices within the network to communicate messages to one another. Touch-screen device 110 may serve as a master device while sensors 212 serve as slave devices. Sensors 212 notify touch-screen device 110 of a sensed condition by sending a local status alert message transmitted from the sensor as a Bluetooth message. Touch-screen device 110 in turn, may change a mode of operation of device 110 from a first-handed mode to a second-handed mode of operation based on the received status-alert message. More particularly, Touch-screen device 110 in turn, may change a mode of operation of device 110 from a first-handed mode to a second-handed mode of operation based on a use of another, differing device (i.e., different than device 110). For example, device 110 may change from a right-hand mode of operation to a left-hand mode of operation based on a handcuff sensor determining that handcuffs have been accessed by an officer, or from a normal mode of operation to a right/left handed mode of operation and vice versa. Thus, once device 110 receives a detected condition via a local status-alert message, device 110 will make a determination whether or not a mode of operation needs to be changed. For example, if a gun-drawn sensor 212 detects a gun has been drawn, device 110 will make a determination that the handed mode of operation needs to be changed. Other conditions for changing the mode of operation may comprise:
a motion sensor 212, for example, a GPS receiver (not shown in FIG. 2) detecting “in motion” or speed/acceleration. This may indicate such conditions as a police office running or chasing a criminal, steadying themselves when in transit, or driving a police car;
A grip senor or a pressure senor 212, detecting pressure. This may indicate such conditions as a police office holding another device for example a Taser/Pepper Spray/Spontoon.

It should be noted that the decision to change the mode of operation of device 110 may be made based on a detected condition of multiple sensors. For example, one sensor 212 may comprise a disarm sensor. The disarm sensor may simply comprise a switch, that when activated or pressed, indicates to touch-screen device 110 to ignore a received gun-drawn alert from a gun-drawn sensor. Another sensor 212 may comprise location-finding equipment (e.g., a GPS receiver) in order to instruct touch-screen device 110 to ignore a received gun-drawn alert from a gun-drawn sensor, for example when an officer enters court, police headquarters, or a washroom.

Expanding on the above, a disarm sensor 212 is provided in FIG. 2 existing, or attached to touch-screen device 110. It should be noted that disarm sensor 212 may be located on or within any device or piece of clothing worn by a public-safety officer. When disarm sensor 212 is activated, touch-screen device 110 will discard telemetry information (i.e., discard local status alert messages) from other sensors. When this occurs, no mode of operation is changed. Alternatively, if the mode of operation has already been changed, the mode of operation may switch back to a dominant-hand mode of operation.

As an example of the above, consider the scenario where a police officer returns home for the evening and wishes to remove a weapon from its holster. A disarm button may be provided that upon pressing, a “full disarm” of all sensors is performed by touch-screen device 110. In other words, touch-screen device 110 ignores telemetry data from all sensors, and will not change a mode of operation from a dominant-hand, or default mode of operation. (It should be noted that a user may pre-program device 110 with default operation, for example, right-handed mode).

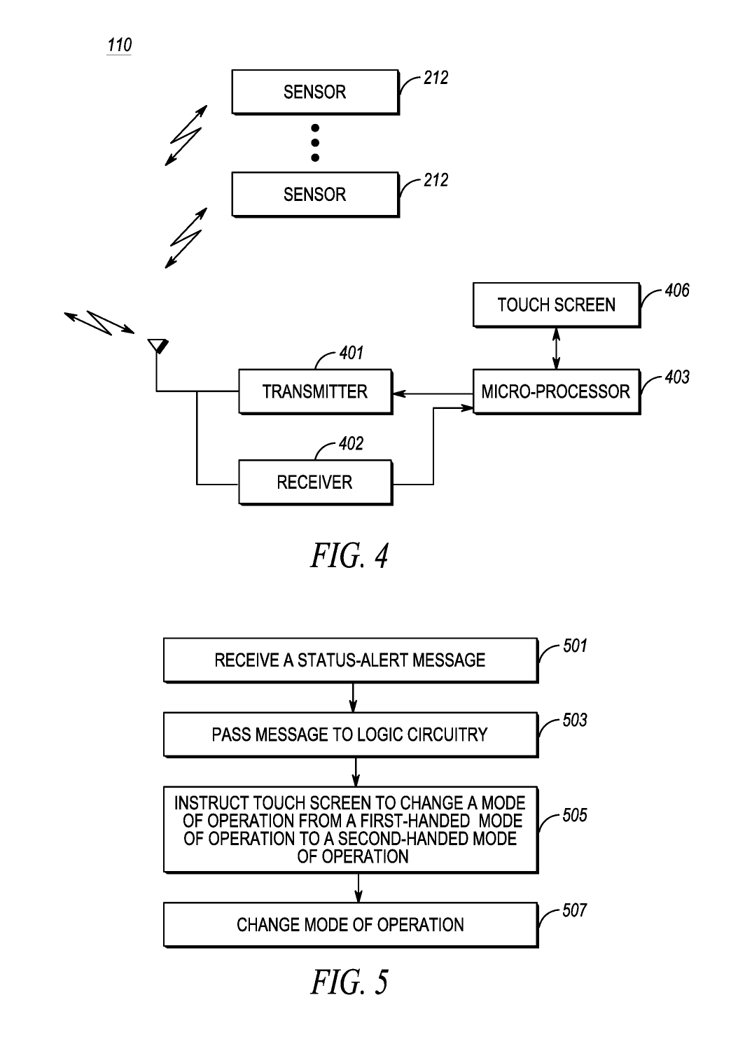

FIG. 4 is a block diagram of a device 110. FIG. As shown, device 110 may include transmitter 401, receiver 402 (which may be wired or wireless), touch screen 406, and logic circuitry 403. In other implementations, device 110 may include more, fewer, or different components.

Transmitter 401 and receiver 402 may be well known long-range and/or short-range transceivers that utilize any number of network system protocols. For example, transmitter 401 and receiver 402 may be configured to utilize Bluetooth communication system protocol for a body-area network, a private 802.11 network, a next-generation cellular communications protocol operated by a cellular service provider, or any public-safety protocol such as an APCO 25 network or the FirstNet broadband network. Although only a single transmitter and receiver are shown in FIG. 4, one of ordinary skill in the art will recognize that multiple transmitters and receivers may exist in device 110 to provide simultaneous communications using any number of communication system protocols.

Touch screen 406 provides both an output interface and an input interface between the device and a user. Touch screen 406 displays visual output to the user. The visual output may include text, graphics, video, and any combination thereof. Some or all of the visual output may correspond to user-interface objects, which are placed onto touch screen 406 in a particular area depending on a mode of operation, as discussed above.

Touch screen 406 also accepts input from a user based on haptic and/or tactile contact. Touch screen 406 forms a touch-sensitive surface that accepts user input. Touch screen 406 detects contact (and any movement or break of the contact) on touch screen 406 and converts the detected contact into interaction with user-interface objects, such as one or more user-interface elements (e.g., soft keys), that are displayed on the touch screen. In an exemplary embodiment, a point of contact between touch screen 406 and the user corresponds to one or more digits of the user. Touch screen 406 may use LCD (liquid crystal display) technology, or LPD (light emitting polymer display) technology, although other display technologies may be used in other embodiments. Touch screen 406 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 406. The touch screen may be analogous to those described in the following: U.S. Pat. Nos. 6,323,846 (Westerman et al.), 6,570,557 (Westerman et al.), and/or 6,677,932 (Westerman), and/or U.S. Patent Publication 2002/0015024A1. The user may make contact with touch screen 406 using any suitable object or appendage, such as a stylus, finger, and so forth.

Logic circuitry 403 comprises a digital signal processor (DSP), general purpose microprocessor, a programmable logic device, or application specific integrated circuit (ASIC) and is configured to determine whether or not to change a handedness mode of operation for device 110 based on the user of another, differing device or object. For example, a local status alert message may have been received from sensor 212 by receiver 402 and passed to logic. If, for example, the local status alert message indicated that a gun had been drawn, microprocessor 303 may then change the mode of operation based on the status-alert message. If, however, a second local-alert message received from sensor 311 comprises a disarm message, logic circuitry 403 may choose not to change the mode of operation.

As is evident, FIG. 4 the receiver in FIG. 4 is configured to receive a status-alert message from a sensor, object, or second device, while the logic circuitry of FIG. 4 is configured to change a mode of operation of the device from a first-handed mode of operation to a second-handed mode of operation based on the received status-alert message.

The receiver comprises a wireless receiver, and the status-alert message comprises a wireless message transmitted from the sensor, object, or second device.

The device of FIG. 4 is configured change a mode of operation of the touch screen from a first-handed mode of operation to a second-handed mode of operation based on a detected use of a second, differing device, wherein the first mode of operation is a right-handed mode of operation, and the second mode of operation is a left-handed mode of operation, or vice versa.

FIG. 5 is a flow chart showing operation of the device of FIG. 4. More particularly, the logic flow of FIG. 5 illustrates those steps (not all necessary) for changing operation of a first device from first-handed mode of operation to a second-handed mode of operation. The logic flow begins at step 501 where wireless receiver 402 receives a status-alert message from a sensor, object, or second device, the sensor, object, or second device differing from the first device. The received message is passed to logic circuitry 403 where use of the object or second device is determined. (step 503). At step 505 logic circuitry instructs touch screen 406 to change a mode of operation from a first-handed mode of operation to a second-handed mode of operation based on the wireless receiver receiving the status-alert message from the sensor, object, or second device. Finally, at step 507, touch screen 406 changes a mode of operation.

As discussed above, the status-alert message comprises a message transmitted from the sensor, object, or second device indicating a status the object, or second device. As an example, the sensor may comprise a gun-drawn sensor or a location and/or speed sensor. Additionally, the step of changing the mode of operation comprises the step of changing the mode of operation from a right-handed mode of operation to a left-handed mode of operation, or changing the mode of operation from a left-handed mode of operation to a right-handed mode of operation, or from a normal mode of operation to a right/left handed mode of operation and vice versa.

In the foregoing specification, specific embodiments have been described. However, one of ordinary skill in the art appreciates that various modifications and changes can be made without departing from the scope of the invention as set forth in the claims below. For example, although the above embodiment was described with sensors attached to objects or devices, with the sensors providing data about the use of their attached devices, one of ordinary skill in the art will recognize that the actual devices or objects themselves may provide such use data. Additionally, the use of the terms “first-handed” and “second-handed” are meant to encompass right-handed, left-handed, and normal-handed (i.e., no-handed preference). The Applicants draw no distinction, between a device providing use data (status-alert message), or a sensor attached to a device providing use data. In other words, satus-alert messages may be received from a sensor, object, or another device. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for changing a mode of operation of a first device from first-handed mode of operation to a second-handed mode of operation, the method comprising the steps of:
receiving with a wireless receiver, a status-alert message from a sensor, object, or second device, the sensor, object, or second device differing from the first device; and
changing the mode of operation from a first-handed mode of operation to a second-handed mode of operation based on the wireless receiver receiving the status-alert message from the sensor, object, or second device.

2. The method of claim 1 wherein the status-alert message comprises a message transmitted from the sensor indicating a status of the object or second device.

3. The method of claim 2 wherein the sensor comprises a gun-drawn sensor, a pressure, and/or grip sensor.

4. The method of claim 2 wherein the sensor comprises a location and/or speed sensor.

5. The method of claim 1 wherein the step of changing the mode of operation comprises the step of changing the mode of operation from a right-handed mode of operation to a left-handed mode of operation, or changing the mode of operation from a left-handed mode of operation to a right-handed mode of operation, or from a normal mode of operation to a right/left handed mode of operation and vice versa.

6. A device comprising:
a touch screen;
a receiver configured to receive a status-alert message from a sensor, object, or second device;
logic circuitry configured to change a mode of operation of the device from a first-handed mode of operation to a second-handed mode of operation based on the received status-alert message.

7. The device of claim 6 wherein the receiver comprises a wireless receiver, and the status-alert message comprises a wireless message transmitted from the sensor, object, or second device.

8. A first device comprising:
a touch screen; and
logic circuitry configured to change a mode of operation of the touch screen from a first-handed mode of operation to a second-handed mode of operation based on a detected use of a second, differing device.

9. The first device of claim 8 wherein the first-handed mode of operation is a right-handed mode of operation and the second-handed mode of operation is a left-handed mode of operation, or vice versa, or the first-handed mode of operation is a normal mode of operation and the second mode of operation is a right/left handed mode of operation.

10. The first device of claim 8 further comprising:
a wireless receiver configured to receive a status-alert message from a sensor, object, or second device, the status-alert message indicating a use of the second, differing device.
